(19) United States
(12) Patent Application Publication
(10) Pub. No.: US 2014/0280119 A1
(43) Pub. Date: Sep. 18, 2014

(54) SEARCH RESULTS MODIFICATION SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/210,689

(22) Filed: Mar. 14, 2014

Related U.S. Application Data
(60) Provisional application No. 61/785,984, filed on Mar. 14, 2013.

(51) Int. Cl. G06F 17/30

(52) U.S. Cl. CPC G06F 17/30867
USPC 707/732

(57) ABSTRACT

A system and method for highlighting particular search results is described. The system receives information and data about retailers and users. The system then receives notice that a user has performed an Internet search (e.g., using a search engine), receives the search results from the Internet search, and modifies the search results at least partially based on the information associated with the various retailers and social network data. The system may provide special offers to the user, highlight specific retailers, and/or add new results customized for the user (e.g., based on the social network and/or other data).

### CLAIM OF PRIORITY

This application claims the benefit of U.S. Provisional Patent Application No. 61/785,984, filed Mar. 14, 2013, entitled, “Search Results Modification Systems and Related Methods,” which is incorporated herein by reference in its entirety.

### BACKGROUND

A simple Internet search can produce thousands of results, which can make it frustrating for an individual to find a particular product or service. At the same time, retailers may be frustrated if their company, products, and/or services do not appear when the individual searches relevant terms.

Various embodiments of the present systems and methods recognize and address the foregoing considerations, and others, of prior art systems and methods.

### SUMMARY

In general, in various embodiments, a computer system is configured for: 1) receiving entity data that includes information and one or more offers associated with an online retailer; 2) receiving social network data that includes purchasing characteristics associated with a particular user; 3) receiving a plurality of results of an Internet search associated with the user; 4) identifying one or more particular search results of the plurality of search results that are associated with the first online retailer; and 5) at least partially in response to identifying the one or more particular search results associated with the online retailer, modifying the plurality of search results at least partially based on the entity data and the social network data. In particular embodiments, the computer system may also be configured for saving the social network data and the entity data to memory. According to various embodiments, the computer system is configured to display the modified search results to the user.

### BRIEF DESCRIPTION OF THE DRAWINGS

Reference will now be made to the accompanying drawings, which are not necessarily drawn to scale, and wherein:

FIG. 1 is a block diagram of a Search Modification System according to one embodiment;

FIG. 2 is a block diagram of an exemplary Logistics Server of FIG. 1;

FIG. 3 shows a flow diagram that generally illustrates various steps executed by the exemplary Search Results Modification Module in FIG. 2 in accordance with various embodiments of the system of FIG. 1; and

FIGS. 4A-4C depict screenshots and descriptions of various aspects and embodiments of the exemplary Search Results Modification Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

Computer systems according to various embodiments are configured to enhance the results of computerized searches (e.g., Internet searches or other searches) by, for example: (1) emphasizing particular search results; (2) rearranging the respective order or prominence in which particular search results are displayed; (3) inserting additional results among the search results; (4) presenting special offers for users; and/or (5) modifying text or images associated with particular search results. In particular embodiments, when a user performs a search using a suitable search engine (e.g., Google®, Bing®, Yahoo!®, etc.), the system is configured to receive the results of the search, and use user, retailer, or other information to determine how to modify the search results. In particular embodiments, the system modifies the search results so that they are tailored to the user and/or so that they focus the user's attention on certain search results or offers. After modifying the search results, the system displays the modified search results to the user.

In a particular embodiment, the system is configured to emphasize particular search results (e.g., particular organic search results) and display an indicium or link to the special offer, which may, for example, be at least partially related to the emphasized (e.g., highlighted) particular search result. In various embodiments, the indicium may include a user-selectable indicium that is displayed adjacent the highlighted particular search result.

In various embodiments, the system is configured to modify search results based on any of a variety of different types of information. Such information may include, for example: (1) the searcher's purchase history; (2) social network data associated with the searcher (e.g., the searcher's likes and/or dislikes as specified on a social network); and/or (3) demographic data associated with the searcher (e.g., the searcher's gender, age, marital status, etc.). In particular embodiments, the system uses this information to generate a set of assumed user preferences for the searcher and then modifies the search results using the assumed user preferences. The user preferences may also be determined based on other personal information such as, for example, the searcher's profession, friends, hobbies, or interests.

In some embodiments, the system may be configured to modify sets of search results based on information specified by and/or related to a particular online retailer. For example, the system may be configured to modify the search results to highlight any search results that are related to products or services provided by any of a list of preferred retailers. As another example, the system may be configured to modify search results to display one or more offers specified by one or more particular retailers that may be relevant to particular search results. In various embodiments, when displaying special offers to the user, the system may be configured to directly insert the special offers into the search results (e.g., by including special offers among the original results for a particular search). For example, if an individual conducts a search for headphones, the system may display, within or adjacent the search results, an offer for a discount on a certain type of headphones. In various embodiments, the system is configured to use a combination of information regarding the searcher and information obtained from one or more online retailers, and/or any other suitable information to modify the search results in one or more of the ways outlined above.

The system may receive the user or retailer data from any of a variety of sources. Such sources may include, for example: (1) data derived from information displayed within a browser (e.g., Chrome®, Internet Explorer®, Firefox®, Safari®, etc.); (2) data obtained by “scraping” information from e-mails stored on, or accessed using, the searcher's computer; (3) a social media account associated with the user; and/or (4) any suitable data store that includes information regarding the searcher or one or more retailers. In a particular embodiment, when displaying special offers to the user, the system is configured to directly insert the special offers into the search results (e.g., by including special offers among the original results for a particular search). In other embodiments, the system is configured to highlight particular search results (e.g., particular organic search results) and display an indicium or link to the special offer, which may, for example, be at least partially related to the highlighted particular search result. In various embodiments, the indicium may include a user-selectable indicium that is displayed adjacent the highlighted particular search result.

The system may be implemented in various ways by one or more entities. In various embodiments, the system is provided by a logistics company, a retailer, the provider of an Internet search service, or any other suitable company.

Moreover, the system may be implemented using a user's computing device (laptop computer, desktop computer, mobile device, etc.), a company's servers (e.g., a particular company associated with the search result's one or more servers, a retailer company's one or more servers, one or more third party servers, etc.), a social network server, or any combination of such computing devices or other devices.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions that execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Search Modification System 10 according to a particular embodiment of the present invention. As may be understood from this figure, the Search Modification System 10 may include one or more Networks 15, a Logistics Server 25, one or more Third Party Servers 35 (e.g., a web hosting server, retailer's server, any other server that hosts websites), a Social Network Server 45 (e.g., a sever associated with any service that allows users to make connections and/or to publically or privately share data, pictures, videos, or information), and one or more of the following: a Mobile Computing Device 12 (e.g., a handheld computing device, a laptop computer, a smart phone, a tablet computer, or any other mobile computing device) or a Desktop Computer 14.

The one or more Networks 15 facilitate communication between the Mobile Computing Device 12, Desktop Computer 14, Logistics Server 25, Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, both the communication link between the Mobile Computing Device 12, Desktop Computer 14, Logistics Server 25, Third Party Servers 35, and Social Network Server 45 are implemented via the Internet using Internet Protocol (IP). The communication link between the Logistics Server 25, Third Party Servers 35, and Social Network Server 45 may be, for example, implemented via a LAN or WAN.

It should be understood that the Servers 25, 35, and 45 do not necessarily need to be deployed over the network. For example, in various embodiments, any or all of Severs 25, 35, and 45 may be deployed locally on the user's computer, tablet, and/or mobile device.

FIG. 2 shows a block diagram of an exemplary embodiment of an exemplary Logistics

Server 25 that is configured for executing a Search Results Modification Module 300. It should be understood based on this disclosure that any suitable computers (e.g., any of the computing devices shown in FIG. 1) may be used to execute this module and that various steps executed by the module may be executed on different computers.

The Logistics Server 25 may include several basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD Rom drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and the Search Results Modification Module 300. For simplicity and brevity, these modules are merely exemplary and may represent a number of program modules which control certain aspects of the operation of the Logistics Server 25 with the assistance of the Processor 60 and the Operating System 80. The Search Results Modification Module 300 is described in more detail below.

### Search Results Modification Module

As shown in FIG. 2, certain embodiments of the Search Results Modification Module 300 are configured to gather and utilize data and provide enhanced search results. The Search Results Modification Module 300 may operate alone or in combination with the Operating System 80 to perform the functions shown in FIG. 3. It should be understood by one skilled in the art that certain embodiments of a Search Results Modification Module 300 may perform the functions shown in FIG. 3 in an order other than the order shown in FIG. 3. It should also be understood that various systems, when executing a Search Results Modification Module 300 may omit particular functions or perform additional functions in performing the functions of the Search Results Modification Module 300.

### Exemplary Functionality of the Search Results Modification Module

### Receipt of Data

Beginning at Step 302, according to various embodiments, the Search Results Modification Module 300 receives data associated with one or more first online retailers including information and one or more offers associated with the first online retailer. The system may be configured to receive the entity data from any appropriate source. In various embodiments, the system is configured to receive the entity data from a web browser and/or client device. In further embodiments, the system is configured to receive the entity data from one or more servers associated with the first online retailer (e.g., the one or more Third Party Servers 35).

The first online retailer may be any online retailer. In various embodiments, the online retailer is a retailer that sells one or more various brands, but specializes in a specific type of merchandise (e.g., an online shoe retailer). In other embodiments, the online retailer specializes in one specific brand (e.g., Calvin Klein®). In still other embodiments, the online retailer is a general online retailer (e.g., Amazon®). In other embodiments, the online retailer specializes in services, group discounts, and/or whole sale items.

The system may receive one or more different types of information associated with the first online retailer, which may include, for example, the first online retailer's name, products that the first online retail is offering for sale, prices for those and other products, current products that are for sale at a discount, and any other information that may be suitable for use by the system to enhance or otherwise modify search results for a user. In some embodiments, the system is configured to receive characteristics of customers who typically purchase from this particular retailer or similar retailers (e.g., such as an age rage, occupation, gender, etc.). In further embodiments, the system is configured to receive information associated with users, other retailers, search terms, and/or any other suitable data associated with the first online retailer and/or business associated with the first online retailer.

As part of Step 302, the system may receive any suitable one or more offers. In various embodiments, the one or more offers are for one or more products sold by the first online retailer. In further embodiments, the one or more offers are for one or more services sold by the first online retailer. In still further embodiments, the system is configured to receive one or more offers associated with the first online retailer, but are for products and/or services associated with another retailer.

The system continues, at Step 304, by receiving social network data including purchasing characteristics associated with a user. The social network data may include any suitable data associated with the social network. In various embodiments, the social network data may include data regarding the user's interests and hobbies as indicated on the social network (e.g., data that includes particular pages that the user has ‘liked’ on a particular social network such as Facebook®).

In some embodiments, the social network data includes data associated with one or more purchases the user has made associated with the social network (e.g., one or more items associated with one or more advertisements on the social network, one or more items the user has purchased then posted about purchasing on the social network, one or more items the user has purchased by clicking on an advertisement on the social network, etc.). In further embodiments, the social network data includes data associated with the type of advertisements the user has selected (e.g., clicked) while using one or more social networks (e.g., the user typically selects advertisements associated with shoes). In further embodiments, the social network data includes purchasing characteristics that include one or more buying habits associated with the user as tracked by the social network (e.g., buying habits based on purchases the user has shared on the social network, purchases the user has made while logged into the social network, etc.).

At Step 306, the system continues by receiving results of an Internet search associated with the user. In various embodiments, the search results are a series of results based on one or more search terms entered by the user that include particular search results. The particular search results may be arranged in any suitable, including in a list. In a particular example, the search results include ten particular search results in a list ranked from the most relevant particular search result at the top of the list to the least relevant particular search result at the bottom of the list.

The system may be configured to receive the results of an Internet search associated with the user in any suitable way. In various embodiments, the system in configured to receive the results from a browser add-on associated with the user. In further embodiments, the system is configured to receive the results from another suitable source, such as, for example, the social network, the first online retailer, another online retailer, and/or third party servers (e.g., the one or more Third Party Servers 35).

In various embodiments, the results are provided by a search engine such as Google®. In further embodiments, the results are from an online retailer. In still further embodiments, the results are from a social network, such as Facebook®.

According to a particular embodiment, the system is configured to receive the results of the Internet search at least partially in response to a request by the user to perform an Internet search (e.g., when a user enters a search query into a search engine). In a particular example, the user accesses a search engine, such as Google®. Continuing with this example, the user then enters (e.g., on an alpha-numeric keyboard) one or more search terms into a field associated with the search engine. The user submits the one or more search terms to the search engine and, at least partially in response to the search term being submitted by the user, the search engine performs a search based on the one or more search terms. The system, in this example, is then configured to receive results of the search (e.g., one or more particular search results arranged in a list of search results).

The results may include any suitable particular results. In a particular embodiment, the results include one or more products or services the user may wish to purchase (e.g., one or more particular search results including specific products and/or services). In other embodiments, the results include images, videos, web sites, map information, stock information, or any other suitable information that a search engine may return as relevant to a search performed (e.g., requested) by the user. In further embodiments, the results may include search results for brick and mortar retailers and/or other geographic locations.

### Identify Particular Search Results for Modification

The system, at Step 308, analyzes the search results to identify one or more particular search results that are related to the first online retailer for later modification by the system. The system may be configured to identify the one or more particular search results in any suitable way. In various embodiments, the system may be configured to analyze each particular result and in response to analyzing each particular result, determining whether the search results include the first online retailer (e.g., whether the search results contain one or more links to a webpage, product, service, etc. offered by the first online retailer). In this embodiment, the system is configured to analyze the search results for one or more particular results that directly identify the retailer by name (e.g., one or more particular search results that include the name of the retailer). In another embodiment, the system is configured to analyze the search results for results that identify competitors of the first online retailer (e.g., other online retailers that offer similar products or services to the first online retailer). In further embodiments, the system is configured to analyze the search results by products or services (e.g., to indirectly identify the retailer) to identify the one or more particular search results related to the first online retailer.

The system may be configured to identify any suitable one or more results associated with the first online retailer. In various embodiments, the system is configured to analyze the search results to identify one or more products and/or services (e.g., or related products and/or services) that the first online retailer typically offers for sale. In further embodiments, the system is configured to, at least partially in response to analyzing the search results, identify one or more products and/or services of one or more competitors of the first online retailer. In still further embodiments, at least partially in response to analyzing the search results, the system is configured to identify one or more accessories or substantially similar products and services to the one or more products and/or services typically offered by the first online retailer. In a particular example, if the user has entered the search terms “digital cameras” and the first online retailer sells one or more camera cases, the system may be configured to identify one or more search results for retailers that sell digital cameras as one or more search results that are related to the first online retailer.

According to particular embodiments, the system may be configured to save the received first online retailer data (e.g., the entity data), the received social network data, the received results of the Internet search, and/or the identified one or more results (collectively the “received data and results.”). According to a particular embodiment, the system is configured to save the received data and results to an account associated with the user. In another embodiment, the system is configured to save the received data and results to a database associated with a logistics company.

In various embodiments, the system is configured to save the received data and results in any suitable location. In a particular embodiment, the system is configured to save the received data and results to one or more servers associated with a logistics company. In further embodiments, the system is configured to save the received data and results to one or more servers associated with a third party (e.g., the one or more Third Party Servers 35). In still further embodiments, the system is configured to save the received data and results to a client device associated with the user.

### Modify Search Results

At Step 310, at least partially in response to identifying search results related to the first online retailer, the system modifies the search results at least partially based on: 1) the entity data; 2) the social network data; and/or 3) the received search results. The system may be configured to modify the search results in any suitable way or any combination of suitable ways. In various embodiments, the system is configured to modify the search results by highlighting particular search results, such as those related to the first online retailer. The system may be configured to highlight the particular search results in any suitable way, such as, for example, by changing the font style or color in which the search result is displayed, by placing an indicia such as a star adjacent the search result in the listing of search results, and/or by modifying the result in any other suitable manner to highlight or make the result more prominent.

In some embodiments, the system is configured to modify the search results by rearranging the search results so the particular search results related to the first online retailer are displayed more prominently than other search results. In a particular example, the search results are displayed in a particular order (e.g., arrangement). Continuing with this example, the system is configured to modify the search results so the identified particular search results appear substantially at the beginning of a list of the search results (e.g., at the top of the results), as the first numbered result, or as the first result displayed to the user.

In further embodiments, the system is configured to modify the search results by displaying a symbol (e.g., such as a logo, a heart, a star, etc.) next to one or more particular results (e.g., the one or more particular search results identified by the system). In a particular embodiment, the symbol may be a user-selectable indicium. In this embodiment, the system may be configured to display any suitable data in response to the user selecting the user-selectable indicium, including, but not limited to: 1) one or more advertisements associated with the search results; 2) one or more offers associated with the search results; 3) information associated with one or more products and/or services; and/or 4) information associated with shipping one or more products associated with the identified search results.

According to various embodiments, the system is configured to modify the search results by displaying offers related to the first online retailer as part of the results. In a particular embodiment, the system may be configured to directly insert a discount offer below a retailer's name appearing in the search results (e.g., where the retailer's name appears in a particular search result of the search results). In another embodiment, the system is configured to place a user-selectable indicium next to the identified particular search results, which the user may then select to display the offer in another webpage, as a pop-up window, and/or to the side of the search results on the same webpage.

In various embodiments, the system is configured to insert additional search results and/or special offers associated with the first online retailer. In a particular example, the first online retailer is a clothing retailer (“XYZ Retailer”). Continuing with this example, the user searches for a particular clothing item, such as, a “red sweater.” The search results in this example do not necessarily display results for a “red sweater from XYZ Retailer. Continuing with this example, the system is configured to insert a search result for a red sweater from XYZ Retailer near the top of the search results.

In one or more embodiments, the system may then be configured to display the modified results to the user. The system may be configured to display the modified search results to the user in any suitable way on any suitable client device. In a particular embodiment, the system is configured to display the modified search results through a web browser plug-in associated with a client device associated with the user. In further embodiments, the system is configured to display the modified search results via a mobile application (e.g., on a mobile client device). In still further embodiments, the system is configured to display the modified search results via email, SMS message, and/or social network message.

### Exemplary Search Results Modification Functionality

FIGS. 4A-4B depict several screenshots of exemplary embodiments of the Search

Results Modification Module 300. The following examples are provided to further enhance understanding of the present systems and methods. It should be understood that the present systems and methods may be embodied in many different forms and the following examples should not be construed as limited to the embodiments set forth herein. Rather, these embodiments are provided so that this disclosure will be thorough and complete, and will fully convey the scope of the present system and method to those skilled in the art.

FIGS. 4A and 4B depict examples of the system visually emphasizing (e.g., highlighting) the results of a particular Internet search. FIG. 4A depicts an exemplary browser display 400A which may be used by a particular user to access and use a particular search engine (e.g., Google®). In this example, the user enters one or more search terms into the search field 402A and the search engine returns results associated with the one or more search terms (as shown, for example at 404A).

As shown in FIG. 4A, “red sweater” has been entered into the search field 402A. At least partially in response to “red sweater” being entered into the search field 402A, the search engine returns a plurality of search results 410A, which includes particular search results, 412A, 414A, and 416A (and/or advertisements related to the search results) associated with the search terms “red sweater.” The system, at least partially in response to receiving the search results, visually emphasizes the particular search results. In this example, the system is configured to visually emphasize particular search results by adding a user-selectable indicium adjacent the particular search results. In this example, the system has added the user-selectable indicia in the shape of hearts at 406A.

The system, in various embodiments, is configured to receive a notification that the user has selected one of the user-selectable indicia (e.g., by clicking an indicium, rolling over an indicium with a pointer device, and/or other suitable way of selecting an indicium, such as selecting the indicium on a touch-screen). At least partially in response to receiving notice of the user selecting the user-selectable indicium, the system is configured to send a message to the user, which may be, for example, an offer or special message for the user associated with the particular search result that the user-selectable indicium is associated with. In FIG. 4A, the system has sent the message “Shop from Nordstrom and enjoy exclusive offers available only to My Choice members” 408A, which is displayed by the client device in any appropriate way.

FIG. 4B depicts a second embodiment of the system visually emphasizing particular search results. In this example, the user has again entered the search terms (or term) “red sweater” into the search field 402B (in this example, the user “enters” the search terms into the search field, but the search terms could be input into the search field in any appropriate way, such as, by being automatically filled in through predictive searching, etc.) and the search engine returns the search results 406B and associated advertisements 404B.

In this example, the system is configured to modify the search results (e.g., based on the data associated with one or more entities, social network data, etc. as described at Step 302 and 304 above) by inserting a new search result 408B above the other search results in the list of search results (e.g., so the new search result appears at the top of the search results). The system is additionally configured to visually emphasize the new search result by adding a dashed-line box around the new search result and providing a user-selectable indicium 410B. As shown in FIG. 4B, the system is configured to send the modified search results to the client device on which the user entered the search terms (e.g., “red sweater”) into the search field 402B to be displayed to the user.

### Alternate Embodiments

Alternative embodiments of the system may include features that are, in some respects, similar to the various components described above. Selected distinguishing features of these alternative embodiments are discussed below.

### Modify Results of an Internet Search Based on One or More Preferences of the User

The system may be configured to analyze and/or modify the results of an Internet search by the user at least partially based on one or more preferences of the user. The one or more preferences of the user may be any suitable preferences including, but not limited to: 1) product and/or service types (e.g., running shoes) specified by the user; 2) certain brands (e.g., the user prefers Nike® shoes); 3) one or more specific attributes of products and/or services (e.g., the user prefers only black shoes, the user prefers only shoes with laces, the user prefers online shoe sellers, the user wears a certain size shoe, etc.) specified by the user; and/or 4) any combination of one or more preferences of the user (e.g., the user prefers black Nike® running shoes).

In particular embodiments, the system may be adapted to modify the results of an Internet search by, for example, displaying search results that align with one or more of the user's preferences before other results of the search. In other embodiments, the system may only display search results that align with one or more of the user's preferences. For example, if a user specifies a preference for shoes from a particular department store, when the user performs a search for shoes, the system may only display search results related to shoes that are available for purchase from the specified particular department store.

Continuing with this example, the system may be configured to receive the one or more preferences of the user in one or more suitable ways. In a particular embodiment, the system is configured to enable the user to indicate the one or more preferences (e.g., the user indicates they prefer Nike® shoes). In another embodiment, the system is configured to assume one or more preferences of the user. In a particular example, the system is configured to receive the one or more preferences of the user via social network data, as received, for example, in Step 304 above and assumes one or more preferences of the user (e.g., the user has indicated on a social network that they are male, so the system receives the social network data indicating the user is male and visually emphasizes search results for men's shoes).

### Display the Preferences and the Modified Search Results

In various embodiments, the system is configured to display the one or more preferences of the user (e.g., at Step 310). In a particular embodiment, the system is configured to display the one or more preferences of the user with the modified search results on the search results webpage (e.g., at Step 310). In further embodiments, the system is configured to display the one or more preferences of the user in a browser window separate from the search results webpage. In still further embodiments, the system is configured to display the one or more preferences of the user in a pop-up style window and/or any other suitable way.

### Enable the User to Modify the One or More Preferences of the User

According to particular embodiments, the system is configured to enable the user to modify the one or more preferences of the user in any suitable way and by any suitable mechanism. In various embodiments, the system enables the user to modify the one or more preferences of the user on the search results webpage (e.g., when the search results are displayed to the user). In other embodiments, the system is configured to enable the user to modify the one or more preferences of the user on a social network, on a logistics provider's website, through a web browser add-on, etc.

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for providing enhanced search results comprising:
at least one processor, wherein the system is configured for:
(A) receiving entity data comprising information and at least one offer associated with an online retailer;
(B) receiving social network data comprising purchasing characteristics associated with a user;
(C) receiving a plurality of results of an Internet search associated with the user;
(D) identifying at least one particular search result of the plurality of search results that is associated with the first online retailer;
(E) at least partially in response to identifying the one or more particular search results associated with the online retailer, modifying the plurality of search results at least partially based on data selected from a group consisting of:
1. the entity data; and
2. the social network data;
wherein the modified search results are displayed to the user on a client device.

2. The computer system of claim 1, wherein:
(A) the plurality of search results are arranged in a particular order; and
(B) modifying the plurality of search results comprises modifying the arrangement of the particular order of the plurality of search results.

3. The computer system of claim 2, wherein modifying the arrangement of the particular order of the plurality of search results comprises arranging the order of the plurality of search results so the identified one or more particular search results appears at the top of the order of the plurality of search results.

4. The computer system of claim 3, wherein the computer system is further configured for highlighting the identified one or more particular search results.

5. The computer system of claim 4, wherein:
(A) the identified one or more particular search results comprises text; and
(B) highlighting the identified one or more particular search results comprises shading the background of the text of the identified one or more particular search results.

6. The computer system of claim 1, wherein the computer system is part of a logistics system.

7. The computer system of claim 1, wherein modifying the plurality of search results comprises adding a user-selectable indicium adjacent the identified one or more particular search results.

8. The computer system of claim 7, wherein the computer system is further configured for:
(A) receiving notice that the user has selected the user-selectable indicium on a client device; and
(B) sending one or more special offers to the client device to be displayed to the user at least partially in response to the user selecting the user-selectable indicium.

9. The computer system of claim 8, wherein the at least one offer is at least partially based on the entity data.

10. The computer system of claim 9, wherein the computer system is further configured for creating a message to be displayed on a social network at least partially based on the one or more special offers.

11. A computer system for providing enhanced search results comprising:
at least one processor, wherein the system is configured for:
(A) receiving entity data comprising information and offers associated with a plurality of online retailers;
(B) receiving social network data comprising one or more purchasing characteristics associated with a user;
(C) saving the social network data and the entity data to memory;
(D) receiving a plurality of results of an Internet search associated with the user;
(E) identifying one or more particular search results of the plurality of search results that are associated with at least one of the plurality of online retailers;
(F) at least partially in response to identifying the one or more particular search results associated with the plurality of online retailers, modifying the plurality of search results at least partially based on:
1. the entity data; and
2. the one or more purchasing characteristics associated with the user,
wherein the modified results are displayed to the user on a client device.

12. The computer system of claim 11, wherein saving the social network data comprises associating the social network data and the entity data with an account.

13. The computer system of claim 12, wherein the computer system is further configured to enable the user to access the account.

14. The computer system of claim 13, wherein the computer system is further configured to enable the user to adjust the one or more purchasing characteristics associated with the user.

15. The computer system of claim 14, wherein the account is associated with a logistics company.

16. The computer system of claim 11, wherein modifying the plurality of search results comprises visually emphasizing one or more of the plurality of search results.

17. The computer system of claim 16, wherein visually emphasizing one or more of the plurality of search results comprises visually emphasizing one or more of the plurality of search results associated with the identified one or more particular search results.

18. The computer system of claim 16, wherein:
(A) the identified one or more particular search results comprises text; and
(B) visually modifying the identified one or more particular search results comprises highlighting the one or more particular search results by changing the background color of the text.

19. A computer system for providing enhanced search results comprising:
at least one processor, wherein the system is configured for:
(A) receiving entity data comprising information and offers associated with a first online retailer;
(B) receiving social network data comprising at least one purchasing characteristic associated with a user;
(C) saving the social network data and the entity data to memory;
(D) receiving a plurality of results of an Internet search associated with the user;
(E) identifying one or more particular search results of the plurality of search results that are associated with the first online retailer;
(F) at least partially in response to identifying the one or more particular search results associated with the first online retailer, modifying the plurality of search results at least partially based on the entity data and the social network data, wherein modifying the search results comprises highlighting the identified one or more particular search results of the plurality of search results that are associated with the first online retailer; and
(G) displaying the modified results to the user.

20. The computer system of claim 19, wherein:
(A) the plurality of search results are arranged in a particular order; and
(B) modifying the plurality of search results further comprises rearranging the particular order of the plurality of search results.

21. The computer system of claim 20, wherein displaying the modified results to the user comprises displaying one or more advertisements to the user, wherein the one or more advertisements are at least partially based on the at least one purchasing characteristic associated with the user.

22. The computer system of claim 21, wherein displaying the one or more advertisements to the user comprises displaying the one or more advertisements to the user at least partially based on the user selecting a user-selectable indicium.

23. The computer system of claim 22, wherein the computer system is further configured for using the modified search results to display one or more customized messages for a social network comprising data associated with the one or more advertisements.

24. The computer system of claim 19, wherein identifying one or more particular search results of the plurality of search results comprises comparing the entity data with the plurality of results of the Internet search associated with the user to identify one or more particular search results of the plurality of search results associated with the first online retailer.

25. The computer system of claim 24, wherein:
(A) the information and offers associated with the first online retailer comprises the type of products the first online retailer offers for sale; and
(B) comparing the entity data with the plurality of results of the Internet search comprises comparing the type of products the first online retailer offers for sale with the plurality of results of the Internet search to identify one or more particular results of the Internet search associate the type of product the first online retailer offers for sale.
